(19) United States
(12) Patent Application Publication
(10) Pub. No.: US 2006/0041441 A1
(43) Pub. Date: Feb. 23, 2006

(54) System and method for managing legal services

(76) Inventors: Lawrence H. Framme III, Richmond, VA (US); Frances S. Framme, Richmond, VA (US); Nicole T. Lambert, Richmond, VA (US)

Correspondence Address: HUNTON & WILLIAMS LLP;East Tower, Riverfront Plaza, 951 E. Byrd St., Richmond, VA, 23219-4074, US

(21) Appl. No.: 10/923,213

(22) Filed: Aug. 20, 2004

(51) Int. Cl. G06Q 99/00

(52) U.S. Cl. 705/1

(57) ABSTRACT

A system and method for managing legal services is disclosed. The method includes receiving a request for legal services from a member of a pre-paid legal service, collecting information from the member about a legal problem, storing the information as a record in a computer database and determining whether one of a plurality of attorneys associated with the pre-paid legal service is available to speak with the member within a predetermined period of time. The member is then assigned a position in a member queue to speak with an available attorney or if no attorney is available, the member is designated for a call-back by the pre-paid legal service at which point the member is then assigned a position in the member queue. A consultation is provided to the member by the available attorney.

### BACKGROUND OF THE INVENTION

Over the last several decades, the number of civil lawsuits filed, criminal charges lodged and regulatory proceedings instituted throughout the United States has grown at a near geometric progression. At the same time, the number of laws passed or changed by state and federal legislatures and regulations considered and imposed by state and federal administrative bodies has also grown at an ever increasing rate. Even as the volume of litigation, legislation and regulation has increased, the complexity of these has increased as well. As a result, individuals and businesses are regulated by a vast number of complex laws, regulations and legal precedents that are continually changing. These changes have drastically increased the need of individuals and businesses for prompt legal advice and counsel. At the same time, the increased volume and complexity of these changes have dramatically increased the cost of legal services and made it difficult, in some cases prohibitive, for many individuals and businesses to afford needed legal services.

About 30 years ago, pre-paid legal service organizations developed in the United States to help businesses and individuals obtain needed legal services. While pre-paid legal services were widespread in Europe, the concept was relatively new to the United States. The concept of pre-paid legal services is similar to the original concept of pre-paid health plans. That is, a client would “pre-pay” legal expenses to an organization at a regular, periodic rate and then would call upon that organization to provide legal services upon demand at a time of need at no additional cost or at a reduced cost. The pre-paid organization attempts to build a large client (membership) base in order to take advantage of statistical predictabilities of need and volume purchasing of legal services from legal service providers.

As the membership base of the pre-paid organizations increased, the challenges of providing prompt service to the members (clients) increased as well. Traditional law firms are generally unaccustomed to high volume counseling to many individual clients and are not organized to promptly service a continuous, high volume demand of hundreds of clients per day for consultation. As a result, traditional law firm organizations have difficulty servicing this high volume, very demanding practice. Moreover, because a fundamental premise of pre-paid organizations is the ability to negotiate “volume discounts” with legal service providers, traditional law firm organizations face significant financial obstacles in promptly meeting the high volume demand of the pre-paid membership base. These pressures of high volume and discount pricing result in increased costs for the law firm at the same time that the pre-paid organization demands discounted fees.

Because of the large membership base a pre-paid legal service may have, a member may have difficulty receiving legal advice with the level of urgency the member may believe is required to resolve the issue. Prior methods for putting a member in contact with an attorney at a law firm providing service to pre-paid members typically involve a receptionist or other customer service representative taking initial information from the member regarding the nature of the legal problem, along with a number where the member could be reached. This information is then distributed to attorneys in the form of a list of members and phone numbers, from which the attorneys attempt to call back members at the phone number provided.

Under these prior methods, hours, or even days, may pass until the attorney has an opportunity to call the member back. This may result in the member's inability to get an answer to an urgent legal question and/or have the effect of communicating to the member that his or her legal issue did not warrant an attorney's attention.

Furthermore, under prior methods, the member does not know when to expect a call from the attorney. This may result in members unwilling to wait by a phone for a long period of time, thus increasing the likelihood of an unsuccessful attempt by the attorney to reach the member. The inability of an attorney to reach a member who was not near a telephone when the attorney calls the member may further compound the attorney's inability to render legal advice to the member. Each unsuccessful attempt by an attorney to reach a member also results in lost productivity of the attorney, the value of whose time is more economically spent rendering legal advice and not calling phone numbers until a member is reached.

In short, the existing methods of contacting and rendering counsel to a member of a pre-paid legal service wastes large amounts of attorney time and law firm resources. Since attorney time is the most expensive resource within a law firm, these losses are very expensive to the law firm and result in great difficultly in providing the prompt, cost effective services desired in a pre-paid legal services concept.

These and other drawbacks are found in prior methods of managing legal services.

### SUMMARY OF THE INVENTION

Accordingly, it may be desirable to provide a system and method for managing legal services that allow members of a pre-paid legal service to speak with an attorney without the need to wait for long periods of time for an attorney to return the member's call and thus to quickly provide an initial consultation to the member. It may also be desirable to provide a system and method for managing legal services that allows attorneys providing services to pre-paid legal service members to maximize the value of their time by spending more time rendering legal advice and little time trying to contact members.

Systems and methods to achieve these and other goals are described in the exemplary embodiments contained herein.

An exemplary embodiment of a method for managing legal services comprises receiving a request for legal services from a member of a pre-paid legal service, collecting information from the member by an intake representative about a legal problem, storing the information as a record in a computer database, assigning the record a case number and providing the case number to the member, determining whether at least one of a plurality of attorneys associated with the pre-paid legal service is available to speak with the member within a predetermined period of time, assigning the member a position in a member queue to speak with an available attorney, and providing a consultation to the member by the available attorney.

An exemplary embodiment of a system for managing legal services comprises at least one electronic database, a plurality of workstations in electronic communication with one another and the database over a network, a plurality of telephones in electronic communication with one another and with the workstations, and a set of instructions to route member calls and monitor the activity of the workstations and the telephones.

Additional aspects, features and advantages of the present invention will be more apparent when considered in light of the following detailed description of exemplary embodiments of the invention.

### BRIEF DESCRIPTION OF THE DRAWINGS

FIG. 1 is a flowchart showing a method according to an exemplary embodiment of the invention.

FIG. 2 is a flowchart showing one aspect of the method of FIG. 1 in more detail.

FIG. 3 is a flowchart showing another aspect of the method of FIG. 1 in more detail.

FIG. 4 is a flowchart showing another aspect of the method of FIG. 1 in more detail.

FIG. 5 is an illustration of a system according to an exemplary embodiment of the invention.

FIG. 6 is another illustration of a system according to an exemplary embodiment of the invention.

FIG. 7 is an exemplary screen shot illustrating attorney monitoring according to an exemplary embodiment of the invention.

### DETAILED DESCRIPTION OF EXEMPLARY EMBODIMENTS

A system and method for managing legal services is disclosed. The system and method provide a member of a pre-paid legal service with reduced waiting time to speak with an attorney, while attorneys associated with the pre-paid legal service are able to spend a larger percentage of their hours working on matters that directly advance the members' legal matters.

According to exemplary embodiments of the invention, a member of a pre-paid legal service contacts the service to request a consultation on a legal matter, typically, but not necessarily, by a call over a telephone network. An intake representative collects information from the member to determine the particular area of law to which the member's request pertains, which information is recorded in a computer database. Depending on the area of law identified by the member, the intake representative may question the member to collect specific information relevant to that particular area of law.

A signal identifies to the intake representative whether an attorney from a pool of attorneys is available to speak with the member, that is, whether an attorney is either free to receive a member call, i.e. in a “ready” status, or is expected to be in ready status to speak to the member within a predetermined period of time, typically 3-5 minutes. If so, the member is assigned a position in a member queue. From the member queue, the member's call may be taken out of the queue in turn to speak with an attorney from the pool. If, for any reason, an attorney does not become available within the predetermined time, the member is routed back to the intake representative or a customer service representative. The member may then be given the option to continue to wait for an attorney or be designated for a call-back to speak with an attorney at a later time.

If the signal indicates that no attorneys are available, for example, if all attorneys are either on a call with other members or are otherwise unable to speak with the member, the member is designated to receive a call-back from the pre-paid legal service when an attorney becomes available. Once attorneys are again available, the signal changes back to indicate that incoming member requests may be directed to the member queue. Those members who were not originally placed in the member queue receive a call-back and are transferred to the member queue just as if the member had initially called during a period when an attorney was available.

Once the member is transferred to an attorney, the member and the attorney engage in an initial consultation and the attorney may render legal advice to the member. During the call and for a predetermined period of time thereafter, the attorney is unavailable to take new incoming calls. Following the consultation, the attorney is given a predetermined amount of time, typically about 5 minutes, that is designated as a “work” status. Work status provides the attorney time to take notes after the call is complete before returning to ready status to take a new call from a different member. The attorney's activity may be monitored at a customer service representative's workstation. An electronic indication sent to the workstation from the attorney's workstation may indicate that the attorney has returned to ready status, which, if no other attorneys were already available, also results in a change to the signal that indicates attorney availability displayed to the intake representative.

In some cases, an attorney expected to be available within the predetermined member queue wait time does not become available. For example, an attorney may only be expected to spend a specific amount of time in work status, so that an attorney in work status may be considered an available attorney when determining whether to place a member in the member queue or designate the member for a call-back. However, if the attorney needs to spend additional time in work status and no other attorney from the pool is ready to speak with the member, the member's wait in the member queue may exceed the predetermined wait time without being transferred to an attorney. In this situation, the member's call is routed back to the intake representative or a customer service representative monitoring the member queue and the member may be given an opportunity to continue to wait in the member queue or to receive a call-back when an attorney becomes available. Typically the call is routed back to the customer service representative from the member queue via a customer service queue.

In some embodiments it may be desirable for incoming member calls to be placed on hold, for example, if the number of incoming member calls exceeds the number of intake representatives available to take the calls. These calls may also be placed in the customer service queue. In this manner, the customer service queue may include a variety of member calls to be handled by the intake or customer service representatives. Calls routed to the customer service queue from the member queue may be designated as urgent and given priority for handling by either an intake representative or customer service representative before any other calls in the customer service queue are handled.

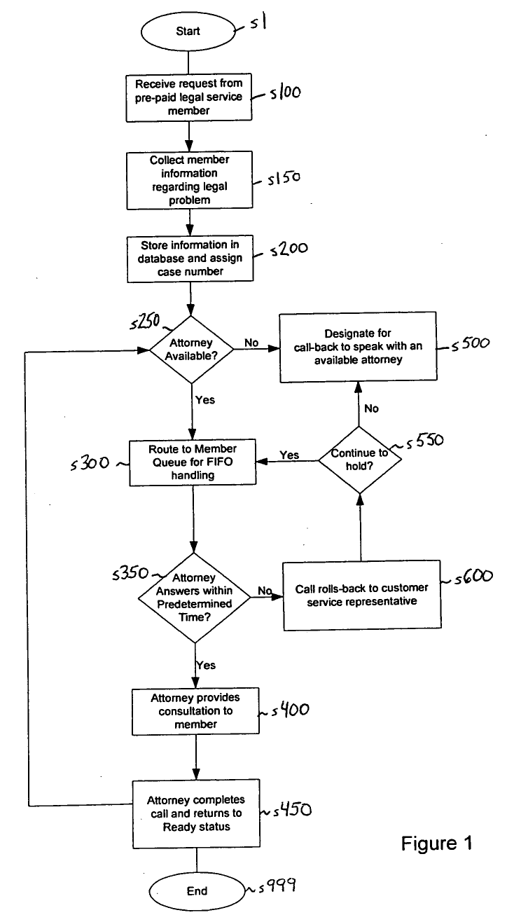

An exemplary embodiment of the invention is shown in FIG. 1. In FIG. 1, a request for legal advice is received from a pre-paid legal service member at s100. Although the request is typically received via a telephone network as described herein, the member's request and subsequent interaction with the pre-paid legal service could also take place through other forms of interactive communication, such as over the internet via a secure instant message service associated with the pre-paid legal service, for example. Typically, the member's call is answered by an intake representative, who may perform duties similar to a traditional receptionist, for example. After the call is received, information about the pre-paid legal service member and the member's legal problem is collected, as shown at s150.

The collected information is stored as a record of an electronic database and the member is given a case number that may be used to identify the member's database record at s200. The intake representative then determines at s250 whether an attorney is available to speak to the member, i.e. whether an attorney is currently ready to speak with the member or is expected to be ready to speak with the member within a predetermined wait time, typically 3 to 5 minutes. Whether an attorney is available is communicated to the intake representative by some type of signal, which conveniently may be in the form of a green or red light, for example, displayed as an icon to the intake representative's workstation where a green light indicates attorney availability and a red light indicates no attorney availability. If the light is green, the member is transferred to a member queue at s300, where calls are typically handled on a first-in, first-out basis by an available attorney who is one in a pool of attorneys associated with the pre-paid legal service and is designated to take member calls.

A member is typically routed to the member queue only if an attorney is available. If the signal indicates that an attorney is not ready to speak with the member within the predetermined wait time, the member is given priority for a call-back when an attorney becomes available, or within a window of time indicated by the member. When an attorney becomes available, the member is then contacted, typically by telephone. If the member answers the call-back, the member is assigned a position in the member queue.

In some cases, an attorney may be designated as available and a member is placed in the member queue at s300, but for some reason no attorney is able to speak with the member within the expected wait time. Once the predetermined wait time has elapsed and an attorney has not removed the member's call from the member queue to provide a consultation, the member's call is directed back to a customer service representative or intake representative at s600. The member is given the opportunity to continue to hold and be placed back in the member queue at s550 at the member's current place in line. Alternatively, the member is given the opportunity to be designated for a call-back when an attorney becomes available at s500. A member who has already waited in the member queue may be given priority for a call-back over a member who was not placed in the queue as a service to balance any inconvenience that may be experienced by waiting without the opportunity to speak to an attorney. Similarly, members designated for call-backs may be placed at a priority position at the front of the member queue.

In some cases, call volume may be so high that multiple members may be designated for call-backs when none of the attorneys associated with the pre-paid legal service is available. To resolve a back log of call-backs, a call-back queue may be established to rank the order in which call-backs are placed. The call-back queue may be based on the order in which the members' request for legal services was received and/or to reflect a priority call-back to members who previously had already waited in the member queue. Furthermore, in situations where multiple call-backs are needed and one of the members has previously been the subject of an unsuccessful attempt, priority may be given to the member for whom no call-back attempt has yet been made. In certain embodiments of the invention, the call-back queue may be automated to sequentially call members in the call-back queue until a call-back is successful and a member is reached.

Referring again to FIG. 1, once an attorney is in ready status, the member's call is transferred from the member queue to the ready attorney so that the attorney can provide an initial consultation at s400, which may include rendering legal advice and determining whether any additional information is needed or desired to better analyze the member's legal issue. Once the consultation is completed at s450, the attorney may again become an available attorney or the process may end at s999.

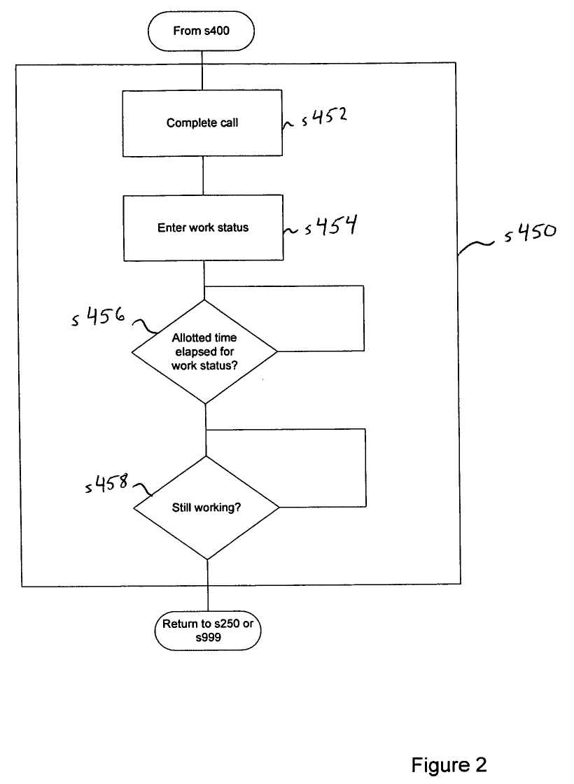

FIG. 2 illustrates s450 of FIG. 1 in more detail. Following the completion of the call with the member at s452, the attorney is designated as entering “work” status at s454. This designation typically begins as soon as the member's call is disconnected and provides the attorney a predetermined period of time to make any additional notes on the member's case while the discussion is still fresh in the attorney's mind. Typically, these notes are made electronically and recorded in the member's case record for later access if the member calls back for additional legal advice.

A timer measures the length of time that the attorney is in work status and whether a pre-determined time allotted for the work status has elapsed at s456. Typically, the attorney is given five minutes in work status, although the amount of time allotted for work status may depend on the area of law to which the preceding call pertained or the length of that call. For example, where the member call lasts over thirty minutes, the attorney may automatically be allotted to be in work status for ten minutes instead of the usual five minutes. Based on the amount of time that the attorney has remaining in work status, the attorney may be designated as an available attorney and any appropriate adjustment may be made to the signal that indicates attorney availability to the intake representative. For example, if the member queue is a three minute queue, an attorney allotted a five minute work status may be considered “available” two minutes into work status. If the attorney does not need the full time in work status, the attorney may return to ready status early and thus take a call from the next member in the member queue. In this way, attorneys who are both “ready,” i.e. waiting to speak with a member, and those who are “working” may be taken into account as available attorneys when determining whether a member should be placed in the member queue or designated for a call-back at s250.

Alternatively, an attorney may occasionally need more than the allotted time in work status. After the time in work status has elapsed, the attorney is occasionally sent an electronic message inquiring whether the attorney is still working at s458 and thus needs additional time to finish. Once the attorney has finished, the attorney sends an electronic indication that the attorney is ready, and thus is available for consideration at s250, which may occur automatically for example, when the attorney saves and/or exits the member's case record.

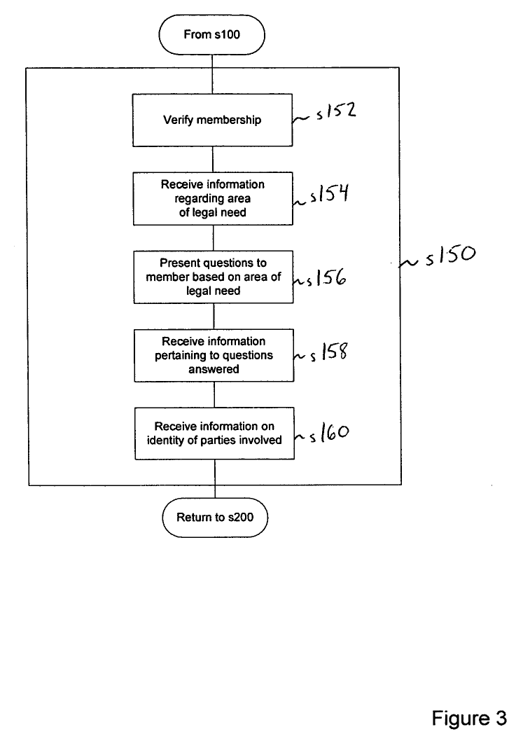

To further assist the attorney to engage in a more meaningful and efficient consultation with the member and to permit the attorney to spend more time rendering legal advice and analyzing the member's legal issue, the initial collection of member information may be as shown in FIG. 3. Upon receipt of the call from the member, the caller's status as a member of the pre-paid legal service is verified at s152. Examples of verification include the use of a touchtone entry of an identification number by the member that is analyzed against an identification number associated with the member by the pre-paid legal service.

Once membership is verified, the intake representative receives information from the member pertaining to a general area of the member's legal need at s154, such as a traffic violation, domestic relations, or estate planning, for example. Once the area of legal need is identified, the member may be presented with additional, more specific questions designed to elicit information pertinent to that particular legal area at s156. For example, in the case of a traffic violation, the questions may relate to the type of violation (speeding, running a stop sign, etc.), the municipality where the member was ticketed, the time of day, the weather conditions, and other information that is received at s158 and which may assist an attorney to quickly become familiar with the member's legal need.

Where additional parties other than the member may be involved in a dispute, the identity of any such parties is also obtained from the member as shown at s160. The intake representative stores information collected from the member as a record in a computer database, as the method passes back to s200 and a case number is assigned to the record that can be used by the member to refer to the case and/or for the attorney to access the database record.

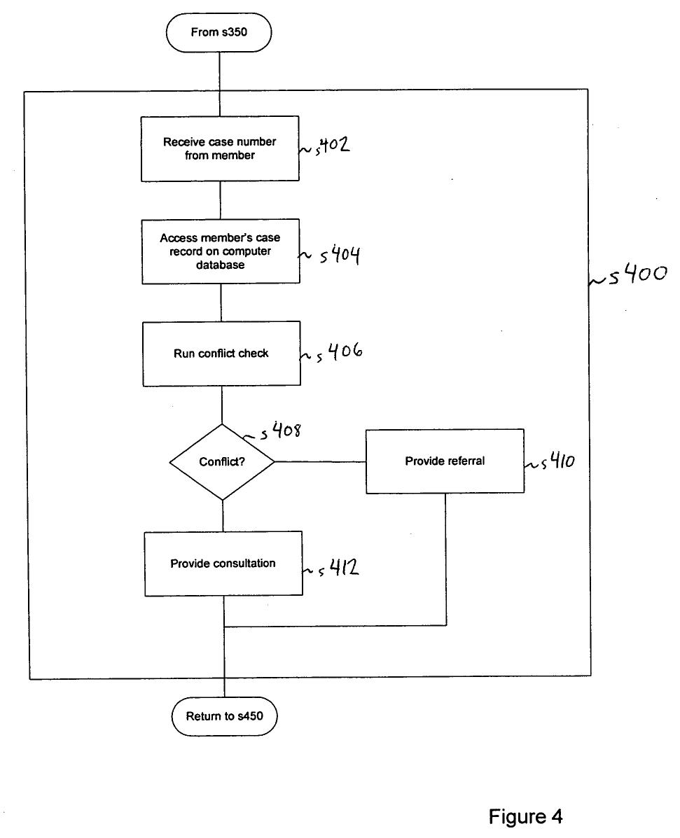

As shown in FIG. 4, the information stored in the database record for the member's legal problem during the information collection stage may later be accessed by the attorney to assist in the consultation with the member. After the attorney has taken the member's call from the member queue, the attorney receives the case number from the member at s402. The attorney has access to the database where the member's record was stored, so that the attorney can access the member's database record and quickly review the information entered by the intake representative at s404, reducing the amount of time spent engaging the member in a discussion to get background information and increasing the percentage of the attorney's time devoted to analyzing the member's legal situation and rendering advice.

The attorney may also use information stored in the database to quickly run a conflict check prior to providing a consultation to the member at s406. The conflict check may be done by an electronic search to compare party information stored in the member's database record against data stored in a client database maintained by the pre-paid legal service. For example, the conflict check may be executed by querying pertinent adverse party information from the member's record against party information stored in the records of all of the other members of the pre-paid legal service.

If the search indicates that a conflict exists at s408 and an attorney determines that it cannot be resolved, the attorney may provide a referral for the member to contact another attorney as shown at s410 and end the call. If no conflict exists, the attorney is free to provide a consultation and may render legal advice to the member based upon the information stored in the member record and any additional information obtained from the member during the call at s412. In certain cases, the attorney may not be able to render pertinent advice without first reviewing additional documents or information. According to one exemplary embodiment of the invention, the attorney can send and receive electronic documents and faxes from the member while the call is occurring. At the completion of the call, the method returns to s450.

Each member's call received by the pre-paid legal service may be identified within the system by call-tracking software. In this manner, every member's call may be identified at one or more monitoring stations, identified by, for example, the phone number of the originating call and which may be stored for later recall. Call identification may permit the progress of each member's request for legal services to be monitored, such as whether a member is still speaking with the intake representative, whether the member has been assigned a position in the member queue, or whether the member is speaking with an attorney. Additionally, the total amount of time the member has been on the call with the pre-paid legal service and the amount of time the member has been at a particular stage, such as how long the member has been speaking with an attorney, can also be monitored. Individual call identification may be advantageous, for example, in the event that a call is inadvertently dropped, so that a member can be easily identified for a priority call-back.

Another advantage of electronically monitoring member call progress and member call history includes the ability to easily identify certain calls as urgent and give them priority over other member calls. For example, where a member has previously unsuccessfully waited in the member queue and was unable to speak with an attorney, the member receives a call-back that may be designated as a priority call routed to the first available attorney.

Attorney activity may also be monitored. This monitoring may be used to keep track of all of the attorneys associated with the pre-paid legal service and their current status. By tracking attorney activity, attorney availability may be determined and thus the appropriate signal can be displayed to the intake representative whether or not incoming member calls should be placed in the member queue or designated for a call-back.

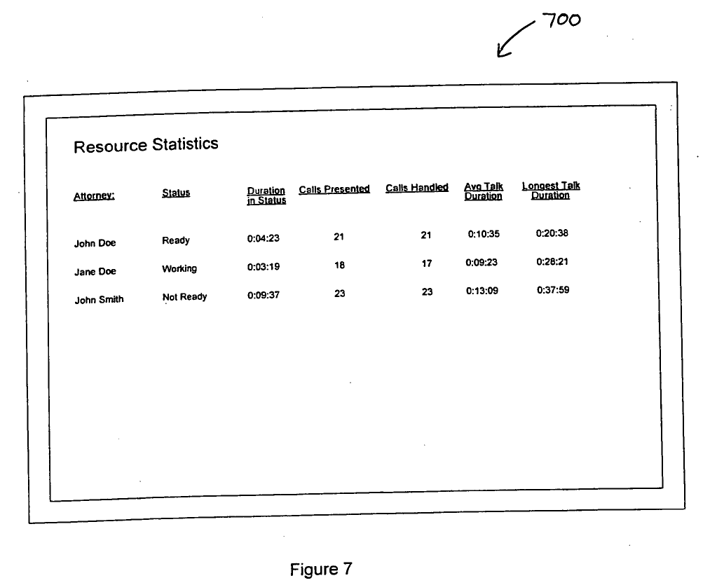

FIG. 7 depicts an illustrative screen shot 700 that shows how attorney activity may be monitored according to exemplary embodiments of the invention, including attorney name, status, duration at that status, along with additional information about the member calls handled by the attorneys.

An exemplary embodiment of a system useful for performing the methods described herein comprises at least one electronic database, a plurality of workstations in electronic communication with one another and the database over a network, a plurality of telephones in electronic communication with one another and with the workstations, and a set of instructions to route member calls and monitor the activity of the workstations and the telephones.

The workstations may be any type of data processor capable of performing a set of instructions. The telephone system used in legal management systems according to a preferred embodiment of the invention is an IP phone system. An IP phone system is a network based phone system that more easily integrates with software for monitoring call progression and attorney activity through the legal management system. The phones are interconnected with, or may be contained within, a workstation, such as WYSE terminal for example.

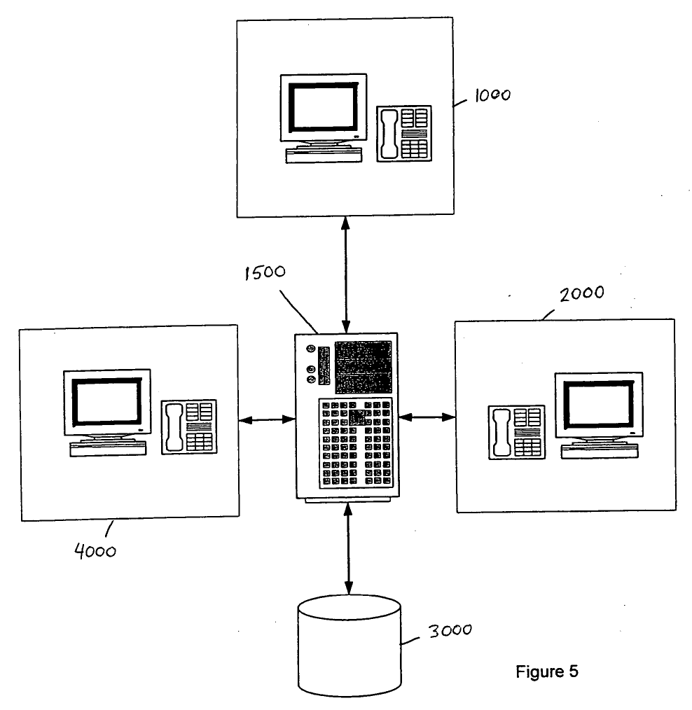

FIG. 5 illustrates how various portions of the system are interconnected according to an exemplary embodiment of the invention. The incoming calls are received at an intake representative station 1000 comprising a workstation and a telephone. The intake representative collects information at the intake representative station 1000 from the member and stores it to a database 3000 over a network managed by a network server 1500. The database 3000 may be any form of electronic storage. The network server 1500 is a data processor and can manage the network using any available network software, but is typically a Citrix server. It should be appreciated that the network server 1500 may comprise one or more interconnected servers or other data processors working together to facilitate electronic communication between the various stations described with respect to FIG. 5.

Once the member's information has been collected at the intake representative station 1000, a set of instructions causes the member's call to be transferred to an attorney at an attorney station 2000, which receives the call via the member queue. The attorney at the attorney station 2000 may access the member's case record via electronic access to the database 3000 through the network server 1500. A monitoring station 4000 provides a customer service representative at the monitoring station 4000 electronic access to the database 3000 and the ability to monitor member call progress and attorney activity over the network server 1500 via monitoring software. The monitoring station 4000 is in electronic communication with the attorney station 2000 to monitor member call progress and the availability of attorneys to speak with incoming members in real-time. The monitoring station 4000 is still further in electronic communication with the intake representative station 1000 to signal whether attorneys are available and members should be placed in the member queue or whether the member should be designated for a call-back when an attorney becomes available. A customer service representative at the monitoring station 4000 typically places the call-backs when one or more attorneys become available and may also designate those call-backs as priority calls for placement at the front of the member queue.

It should be appreciated that each of the intake representative, attorney and monitoring stations may comprise one or more workstations and that the one or more workstations does not need to be in the same geographical location. For example, attorneys could be at locations geographically remote from the intake representative and/or from one another.

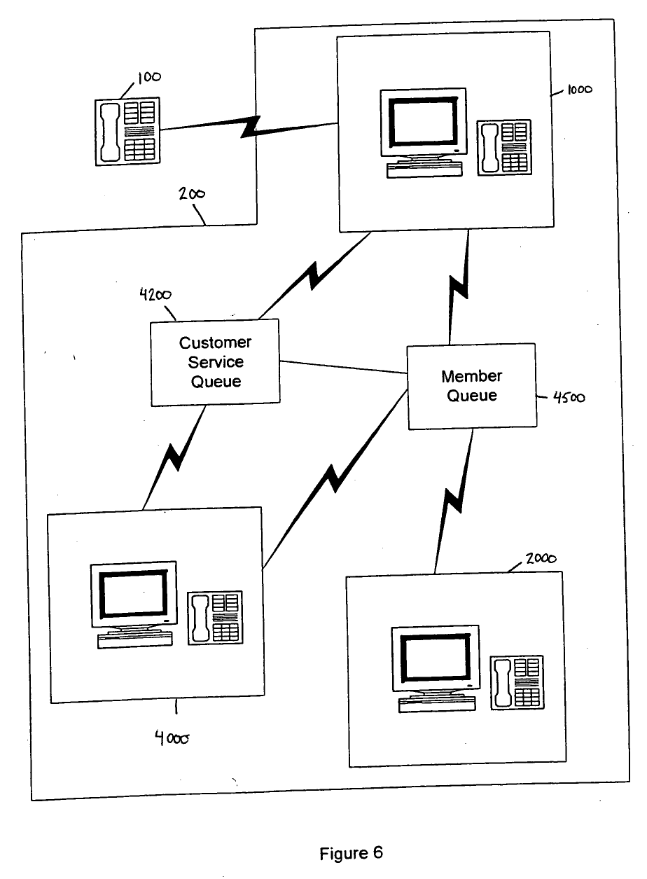

FIG. 6 shows the path of the member's request for legal services in more detail with respect to the stations. The member accesses the pre-paid legal service 200 across any conventional telephone network 100 by dialing a phone number associated with the legal service 200. The member is connected to an intake representative at the intake representative station 1000. After the intake representative has collected the member's information and if an attorney is available, a set of instructions routes the member's call to the member queue 4500. The set of instructions then cause the call to be routed to a ready attorney at the attorney station 2000. If no attorney is ready to speak with the member after a predetermined period of time, the call is routed from the member queue 4500 to a customer service queue 4200 accessible by the monitoring station 4000 or the intake representative station 1000. The member is given an option of receiving a call-back when an attorney becomes available or being returned to the member queue 4500.

Various technologies may be used to provide communication between the various data processors, as well as to allow the data processors to communicate with any other entity; i.e., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, HTTP, UDP, OSI, SOAP, or any other messaging protocol.

As described above, a set of instructions is used in carrying out the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the data processors what to do with the data being processed.

It will be understood that the instructions or set of instructions used in the implementation and operation of the invention may be in a suitable form such that the data processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, any .NET language, and/or JavaScript, for example. Further, it is not necessary that a single type of instructions or single programming language be utilized in conjunction with the operation of the system and method of the invention. Rather, any number of different programming languages may be utilized as is necessary or desirable.

It is to be appreciated that the set of instructions, i.e., the software for example, that enables the system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the data processors of the invention.

Further, the memory or memories used in the data processors that implement the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

The present invention is not to be limited in scope by the specific embodiments described herein. Indeed, various modifications of the present invention, in addition to those described herein, will be apparent to those of ordinary skill in the art from the foregoing description and accompanying drawings. Thus, such modifications are intended to fall within the scope of the following appended claims. Further, although the present invention has been described herein in the context of a particular implementation in a particular environment for a particular purpose, those of ordinary skill in the art will recognize that its usefulness is not limited thereto and that the present invention can be beneficially implemented in any number of environments for any number of purposes.

What is claimed is:

1. A method for managing a pre-paid legal service network comprising:
receiving a request for legal services from a member of a pre-paid legal service;
collecting information from the member by an intake representative about a legal problem;
storing the information as a record in a computer database;
assigning the record a case number and providing the case number to the member;
determining whether at least one of a plurality of attorneys associated with the pre-paid legal service is available to speak with the member within a predetermined period of time;
assigning the member a position in a member queue to speak with an available attorney; and
providing a consultation to the member by the available attorney.

2. The method of claim 1 wherein collecting information comprises determining the existence of additional parties to the legal problem and determining the identity of any such parties.

3. The method of claim 2 further comprising determining whether the additional parties present a conflict of interest prior to providing the consultation.

4. The method of claim 1 wherein determining whether an attorney will be available is indicated by a signal provided to the intake representative.

5. The method of claim 4 further comprising monitoring attorney availability via a real-time monitoring device.

6. The method of claim 1 further comprising receiving the case number by the attorney from the member and accessing the information contained in the member's record stored in the database.

7. The method of claim 1 wherein the collecting information comprises determining an area of law to which the legal problem pertains.

8. The method of claim 7 wherein the collecting information further comprises receiving answers to questions presented to the member based on the area of law to which the legal problem pertains.

9. The method of claim 5 wherein attorney activity is monitored as one of ready, not ready, or working.

10. The method of claim 9 wherein an attorney is determined to be available when at least one attorney's activity is monitored as ready or working.

11. The method of claim 1, further comprising ending communication with the member when an attorney is determined not to be available and designating the member to receive a call-back when an attorney is determined to be available.

12. The method of claim 1 further comprising receiving documentation related to the legal problem by the attorney while the consultation is being provided.

13. A method for managing a pre-paid legal service network comprising:
receiving a request for legal services from a member of a pre-paid legal service;
collecting information from the member by an intake representative about the nature of a legal problem;
storing the information as a record in a computer database;
assigning the record a case number and providing the case number to the member;
determining whether one of a plurality of attorneys associated with the pre-paid legal service is available to speak with the member within a predetermined period of time by monitoring attorney availability via a real-time reporting system;
ending the communication with the member if an attorney is determined not to be available and designating the member to receive a call-back to speak when an attorney is determined to available;
assigning the member a position in a member queue to speak with an available attorney when an attorney is determined to be available;
accessing the record from the computer database; and
rendering legal advice to the member by the available attorney after conducting a conflict of interest inquiry based on information stored in the record.

14. A system for managing a legal service network comprising:
at least one electronic database configured to store pre-paid legal service member case information;
a plurality of workstations in electronic communication with one another and with the network;
a plurality of telephones in electronic communication with one another and with the workstations and with the network; and
a set of instructions to route member calls and monitor activity of the workstations and the telephones.
